(19) United States
(12) Patent Application Publication
(10) Pub. No.: US 2014/0370814 A1
(43) Pub. Date: Dec. 18, 2014

(54) CONNECTING WIRELESS DEVICES

(71) Applicant: International Business Machines Corporation, Armonk, NY (US)

(72) Inventors: Zheng Bi, Parramatta (AU); Jia Yi Shen, Shanghai (CN); Shi Wei, Shanghair (CN); Xiao Feng Yu, Shanghai (CN); Ya Wen Zhao, Shanghai (CN)

(21) Appl. No.: 14/360,696

(22) PCT Filed: Nov. 8, 2012
(86) PCT No.: PCT/CN2012/084297

§ 371 Date: May 27, 2014

(30) Foreign Application Priority Data
Dec. 21, 2011 (CN) 201110456777.5

(51) Int. Cl. H04W 76/02; H04W 4/00; H04W 4/02; H04W 8/00

(52) U.S. Cl. CPC H04W 76/023; H04W 8/005; H04W 4/008; H04W 4/023
USPC 455/41.2

(57) ABSTRACT

The present invention provides a method and system for connecting wireless devices by receiving from a user's wireless device an environmental sound of the environment where the user is located. The method also includes obtaining a list of other wireless devices that are in the same environment as the user, according to the environmental sound and sending the list of wireless devices to the user for the user to select from the list of wireless devices one or more wireless devices for connecting.

### CROSS-REFERENCE TO RELATED APPLICATION

This is a U.S. National Stage of Application No. PCT/CN2012/084297; filed on Nov. 8, 2012; and assigned International Publication No. WO/2013/091449; published on Jun. 27, 2013, which claims priority to Chinese Patent Application No. 201110456777.5; filed Dec. 21, 2011, the contents of each application in their entirety are herein incorporated by reference.

### BACKGROUND

The present invention relates to connecting wireless devices, and more specifically, to a method and system for establishing a connection for wireless devices that are in the same environment.

In some occasions, people want to get connected to and be social with those around them for the same purpose, such as people in the same meeting room, people attending the same speech, or even people sitting in a theater for a concert, etc. Typically, people want to use their cell phones to connect and communicate with each other. Currently, in this scenario, there is no easy way to connect their cell phones and exchange information in a massive way.

One of the solutions which can partially solve the above problem is using Bump. Based on Bump, people can easily connect their cell phones by bumping their cell phones with other people. The drawback of this solution is that people have to first find the other party and then bump their cell phones. However, it is not an easy task to find the other party

Another solution is Bluetooth, which is widely adopted. The problem of Bluetooth here is that it will not consider whether people are in the same environment when connecting with them. Once they are located around, their devices will be shown. And connections via Bluetooth need verification on password; thus it is not applicable in connecting a large number of users.

### SUMMARY

According to one embodiment of the present invention, there is provided a method for establishing a connection between wireless devices. The method includes receiving from a user's wireless device environmental sound of an environment where the user is located, obtaining a list of other wireless devices that are in the same environment as the user, according to the environmental sound and sending the list of wireless devices to the user for the user to select from the list of wireless devices one or more wireless devices for connecting.

According to another embodiment of the present invention, there is provided a method for establishing a connection between wireless devices. The method includes receiving an environmental sound of an environment where a user is located; sending the environmental sound to a server; in response to receiving a list of wireless devices from the server. The method also includes selecting to-be-connected wireless devices, wherein the list of wireless devices is a list of other wireless devices that are determined to be in the same environment as the user according to the environmental sound. The method further includes sending related information of the selected to-be-connected wireless devices to the server.

According to a further embodiment of the present invention, there is provided a system for establishing a connection between wireless devices. The system includes receiving means configured to receive from a user's wireless device an environmental sound of an environment where the user is located and processing means configured to obtain a list of other wireless devices that are in the same environment as the user according to the environmental sound. The system also includes sending means configured to send the list of wireless devices to the user for the user to select from the list of wireless devices one or more wireless devices for connecting.

According to a still further embodiment of the present invention, there is provided a system for establishing a connection between wireless devices. The system includes receiving means configured to receive an environmental sound of an environment where a user is located and sending means configured to send the environmental sound to a server. The system also includes selecting means configured to, in response to receiving a list of wireless devices from the server, select to-be-connected wireless devices, wherein the list of wireless devices is a list of other wireless devices that are determined to be in the same environment as the user according to the environmental sound. The sending means is further configured to send related information of the selected to-be-connected wireless devices to the server.

### BRIEF DESCRIPTION OF THE SEVERAL VIEWS OF THE DRAWINGS

The above and other objectives, features and advantages of the present invention will become more apparent from the more detailed description of exemplary embodiments of the present invention, when taken in conjunction with the figures.

FIG. 1 illustrates an exemplary computer system 100 which is applicable to implement the embodiments of the present invention;

FIG. 2 illustrates a flowchart of a method for establishing a connection between wireless devices according to one embodiment of the present invention;

FIG. 3 illustrates a flowchart of a method for establishing a connection between wireless devices according to another embodiment of the present invention;

FIG. 4 illustrates a flowchart of a method for establishing a connection between wireless devices according to a further embodiment of the present invention;

FIG. 5 illustrates a block diagram of a system for establishing a connection between wireless devices according to one embodiment of the present invention; and

FIG. 6 illustrates a block diagram of a system for establishing a connection between wireless devices according to one embodiment of the present invention.

### DETAILED DESCRIPTION

Aspects of the present invention are described below with reference to methods and systems of embodiments of the present invention, wherein each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer or other programmable data processing apparatus, to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

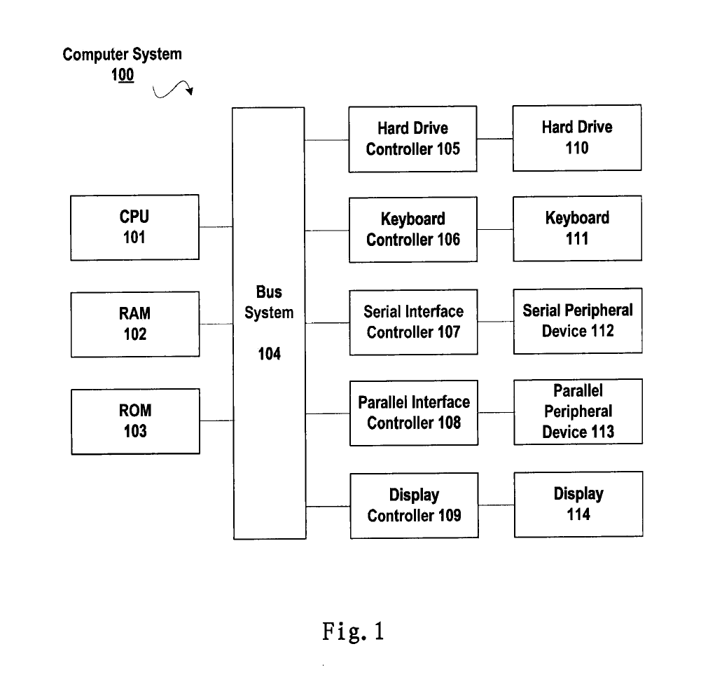

FIG. 1 illustrates an exemplary computer system 100 which is applicable to implement the embodiments of the present invention. As illustrated in FIG. 1, the computer system 100 may include: CPU (Central Process Unit) 101, RAM (Random Access Memory) 102, ROM (Read Only Memory) 103, System Bus 104, Hard Drive Controller 105, Keyboard Controller 106, Serial Interface Controller 107, Parallel Interface Controller 108, Display Controller 109, Hard Drive 110, Keyboard 111, Serial Peripheral Equipment 112, Parallel Peripheral Equipment 113 and Display 114. Among above devices, CPU 101, RAM 102, ROM 103, Hard Drive Controller 105, Keyboard Controller 106, Serial Interface Controller 107, Parallel Interface Controller 108 and Display Controller 109 are coupled to the System Bus 104. Hard Drive 110 is coupled to Hard Drive Controller 105. Keyboard 111 is coupled to Keyboard Controller 106. Serial Peripheral Equipment 112 is coupled to Serial Interface Controller 107. Parallel Peripheral Equipment 113 is coupled to Parallel Interface Controller 108. And, Display 114 is coupled to Display Controller 109. It should be understood that the structure as illustrated in FIG. 1 is only for the exemplary purpose rather than any limitation to the present invention. In some cases, some devices may be added to or removed from the computer system 100 based on specific situations.

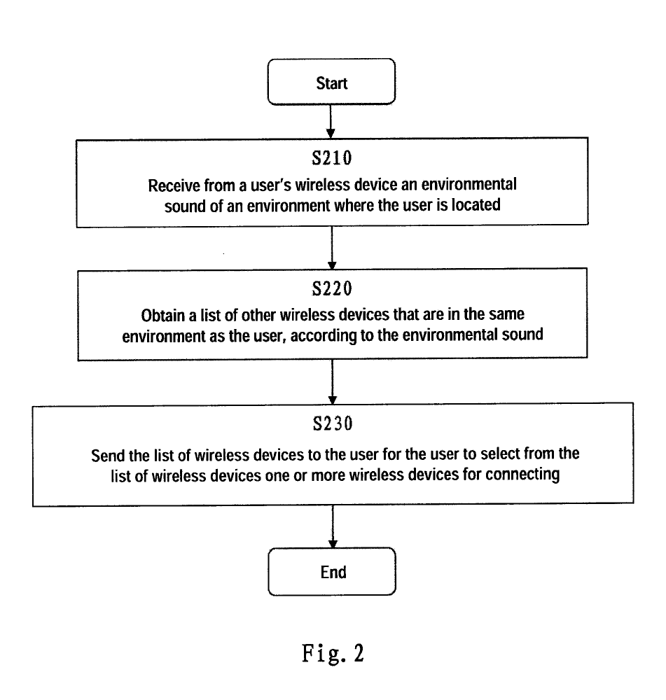

FIG. 2 illustrates a method for establishing a connection between wireless devices according to one embodiment of the present invention. As shown at block 210, environmental sound of the environment where a user is located is received from the user's wireless device. According to one embodiment of the present invention, this receiving step may be started in response to the receipt of the user's request for establishing a connection with other wireless devices. Or, once the environmental sound is received from the user, the process of facilitating the user's wireless device to establish a connection with other wireless devices is started.

As shown at block 220, a list of other wireless devices that are in the same environment as the user is obtained according to the environmental sound. Since the environmental sound received by wireless devices that are in the same environment as the user should be identical with that received by the user's wireless device, after the environmental sound from the user's wireless device is obtained, the environmental sound from other wireless devices can be obtained, and then the environmental sound of the environment where the user is located is matched to the environmental sound from other wireless devices, so as to determine the other wireless devices that are located in the same environment as the user. The environmental sound from other wireless devices may be stored in a server subsequent to being received from the other wireless devices.

As shown at block 230, the list of wireless devices is sent to the user so that the user can select from the list of wireless devices one or more wireless devices for connecting. The list of wireless devices may comprise related information of a wireless device such as identification information of the wireless device, and user information related to the wireless device like user name, photo, email, phone number, address, etc. After receiving from the server the list of other wireless devices that are in the same environment as the user, the user may view information of the other wireless device or user information related to the wireless device, so as to determine whether to connect with the wireless device.

By means of the method for establishing a connection between wireless devices as illustrated in FIG. 2, it is possible to provide a user with information of other wireless devices that are in the same environment with the user in a convenient way. It should be pointed out here that wireless devices may comprise not only cell phones but also any other devices with a wireless communication function.

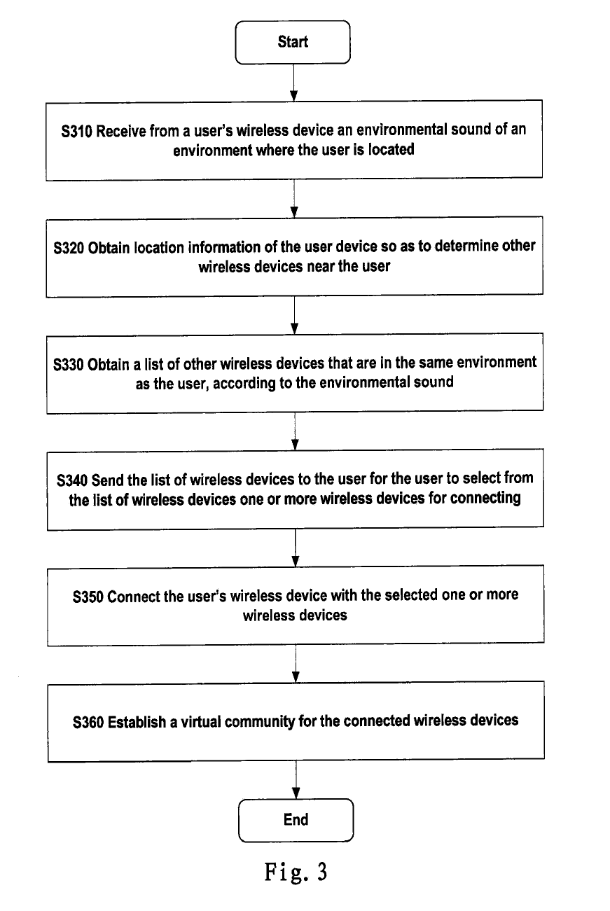

FIG. 3 illustrates a schematic view of a method for establishing a connection between wireless devices according to another embodiment of the present invention. After the user starts an application in his/her wireless device for searching for wireless devices around him/her, like block 210 illustrated in FIG. 2, at block 310 the server receives from the user's wireless device the environmental sound of the environment where the user is located. The environmental sound may be stored in the server upon receipt thereof.

As shown at block 320, location information of the user device is obtained so as to obtain a list of other wireless devices near the user. Considering that there might be millions of wireless devices with their applications starting at the same time while the environmental sound can only be the same in a certain area, the server will consider leveraging GPRS (General Packet Radio Service) information or base station information to only search for wireless devices within a certain distance, thereby greatly reducing the computation load of matching. In addition to GPRS information and base station information, the server may leverage the Global Positioning System (GPS) or Assisted Global Positioning System (AGPS) to determine other wireless devices around the user.

As shown at block 330, based on the list of other wireless devices near the user, a list of other wireless devices that are in the same environment as the user is obtained according to the environmental sound of the user device. For example, after the server determines, according to GPRS information, other wireless devices that might be located around the user, it may be detected whether the environmental sounds from other wireless devices in the list have been received. And after the environmental sounds from other wireless devices is obtained, it is matched to the environmental sound obtained from the user's wireless device, so as to further determine other wireless devices that are in the same environment as the user.

Various known sound processing algorithms like some common signal processing and feature extracting methods may be used to extract a feature from a received sound signal, for subsequent acoustic model processing to thereby match the environmental sounds.

Considering that audio streams of certain environmental sounds as received by wireless devices at different locations in the same environment may be slightly different and timing at different wireless devices may be asynchronous, in this scenario, it is necessary to synchronize the environmental sound of the environment where the user is located with the environmental sounds from other wireless devices, and to compare these environmental sounds after the synchronization, so as to determine other wireless devices that are in the same environment as the user.

Timestamps may be used to ensure synchronization of audio streams of the environmental sounds as received by wireless devices in the same environment. For example, NTPv4 (Network Time Protocol) or other protocols for time synchronization may be combined into the communication between the server and wireless devices to ensure timing synchronization of all client devices. In this scenario, if an audio stream sent to the server has timestamp information, then it can be easily adjusted to a synchronized state.

In addition, a time sequence alignment algorithm may be used to process an audio stream as a time data sequence. There are already many well-known algorithms for time sequence alignment in the prior art, such as the Continuous Profile Model (CPM) and Dynamic Time Wrapping (DTW), etc. Among them, DTW performs a one-to-one alignment on time sequences, and CPM performs a global alignment and is effective to continuous data sequences. Since many mature algorithms for matching audio data exist, they are not detailed here for the purpose of simplicity.

As described above, audio streams of the certain environmental sounds as received by wireless devices at different locations in the same environment may be slightly different; in this scenario, a threshold may be set for matching audio data according to the difference of actual environments according to one embodiment of the present invention. If the difference between the environmental sound of the user's wireless device and the environmental sounds of other wireless device is within the threshold, it is deemed that these two environmental sounds match. The threshold may be automatically set by the server according to the received environmental sound or manually set by the user according to the actual environment where he/she is located.

As shown at block 340, the list of wireless devices is sent to the user so that the user may select one or more wireless devices from the list of wireless devices for connecting. Likewise, the list of wireless devices may comprise related information of a wireless device such as identification information of the wireless device, and user information related to the wireless device such as user name, photo, email, phone number, address, etc.

After receiving from the server the list of other wireless devices that are in the same environment as the user, the user may view information of the other wireless device or user information related to the wireless device, so as to determine whether to connect with the wireless device. At this point, the user may select one or more specific wireless devices or all wireless devices in the list for connecting.

As shown at block 350, upon receipt of the selection of wireless devices from the user, the server connects the user's wireless device with the selected one or more wireless devices. For example, a connection request may be sent to the selected one or more wireless devices on behalf of the user, and upon receipt of the other party's acknowledgment of connection, a connection is established for the user's wireless device with targeted wireless devices.

As shown at block 360, after a connection is established between wireless devices, the server may further establish a virtual community for these mutually connected wireless devices so that wireless devices within the community can easily communicate with one another, share information and accomplish other functions. The present invention uses environmental sounds to check whether wireless devices are in the same place, thereby making it possible for people to easily decide with whom to connect.

A client application may be installed on the wireless device. Once the user of the wireless device starts the client application and searches for people around him/her, the environmental sounds will be recorded by a microphone and sent to the server. Then, a server side application will check the sounds, analyze the sounds according to an algorithm and match a user who has already sent a similar sound to the server. Once the server side application finds a matched sound, the client application will display the corresponding wireless device ID and recommend people to connect with it.

Hereinafter, the present invention will be depicted by way of a concrete example. In this embodiment, depiction is presented by taking a cellphone as an example. However, those skilled in the art may appreciate that the present application is not limited to establishing a connection between cell phones. In fact, any devices with a wireless communication function can be connected with one another by using the disclosure of the present application.

First of all, a user who wants to connect with others opens an application in his/her cell phone and starts the “Search” function, so as to find other users around him/her.

The application records the sounds collected by the cell phone's microphone, converts the collected sound into an audio stream and sends the audio stream to a server. Upon receipt of the audio stream, the server analyzes the audio stream and translates it into a unique digital sequence.

The server matches the digital sequence to digital sequences of similar sounds from other cell phones. Considering that there might be millions of cell phones with their applications starting at the same time while the environmental sound can only be the same in a certain area, the server will also consider leveraging GPRS (General Packet Radio Service) information or base station information to only match those cell phones within a certain distance.

Once the server finds matched cell phones, it will send a list of cell phones back to all the cell phones, and the user can select from the list one or more to-be-connected cell phones for connecting. After establishing a connection between cell phones, the server may save for each cell phone the list of cell phones that are connected with the cell phone. In the meantime, the server will maintain a virtual community for these mutually connected cell phones so that they can communicate with one another. Once a connection is established, the user may select to close the “Search” function. Finally, the application is exited so that the user will disconnect from others.

By means of the present invention, people can locate other wireless devices, such as those in the same room, etc, in a more precise way. Using other information like GPS location can hardly fulfill this job, and sometimes, GPS does not work indoors. In addition, people do not have to physically face others when trying to connect with them by using the claimed technique. It is of great value for those who are reluctant to perform fact-to-face social activities. They can get connected via an application on the wireless device first. Moreover, people can connect with others in a batch rather than one by one.

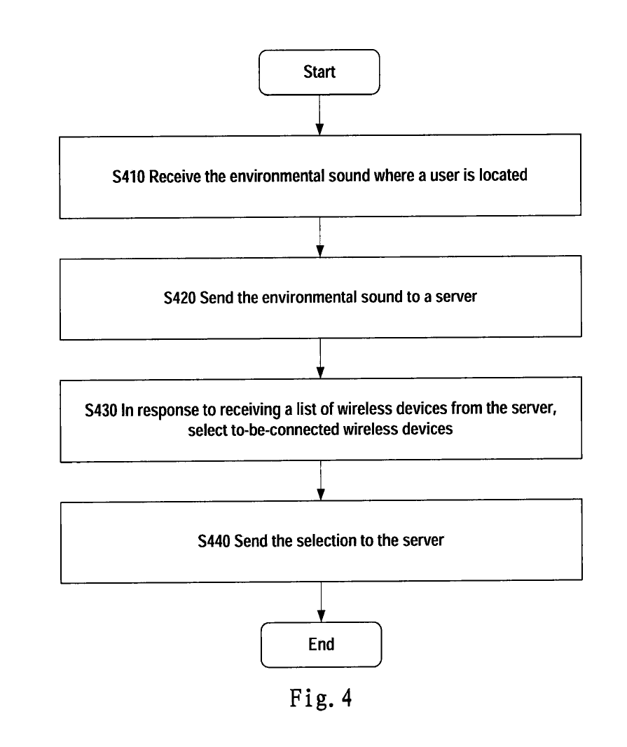

FIG. 4 illustrates a method for establishing a connection between wireless devices according to another embodiment of the present invention. The method is implemented at a user's wireless device client side. As shown at block 410, the environmental sound of the environment where the user is located is received, wherein the environmental sound may be collected by a microphone on the user's wireless device. As shown at block 420, the environmental sound is sent to a server.

Next, as shown at block 430, to-be-connected wireless devices are selected in response to receipt of a list of wireless devices from the server, wherein the list of wireless devices is a list of other wireless devices that are determined to be in the same environment as the user according to the environmental sound. Then,

As shown at block 440, related information of the selected to-be-connected wireless devices are sent to the server so as to establish a connection with the selected wireless devices. After the selected wireless devices agree to be connected with the user, the user's wireless device establishes a wireless connection with the selected wireless devices and performs communication accordingly.

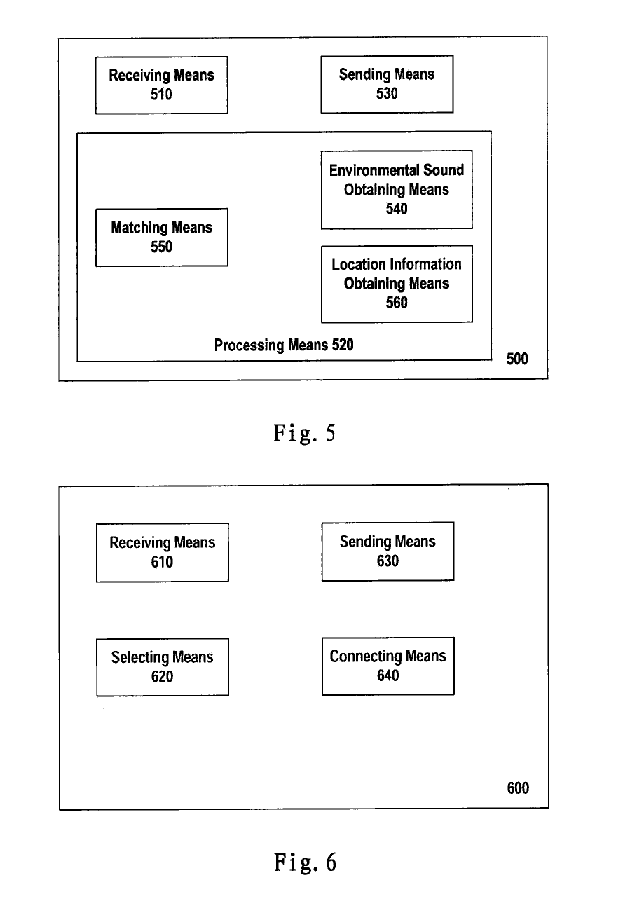

FIG. 5 illustrates a system 500 for establishing a connection between wireless devices according to one embodiment of the present invention. The system 500 includes receiving means 510 configured to receive from a user's wireless device an environmental sound of an environment where the user is located. The system 500 also includes processing means 520 configured to obtain a list of other wireless devices that are in the same environment as the user according to the environmental sound and sending means 530 configured to send the list of the wireless devices to the user for the user to select from the list of wireless devices one or more wireless devices for connecting.

According to one embodiment of the present invention, the processing means 520 further includes environmental sound obtaining means 540 configured to obtain environmental sounds from other wireless devices; and matching means 550 configured to match the environmental sounds in the environment where the user is located to the environmental data from other wireless devices, to determine other wireless devices that are in the same environment as the user.

According to one embodiment of the present invention, the obtaining means 520 further includes location information obtaining means 560 configured to determine other wireless devices near the user's wireless device according to location information of the wireless device. After obtaining the location information of the user's wireless device, the environmental sound obtaining means obtains environmental sounds from the determined other wireless devices around the user's wireless device.

According to one embodiment of the present invention, the location information may be one or more of General Packet Radio Service GPRS information, Global Positioning System GPS information, and Assisted Global Positioning System AGPS information. Since there might be millions of wireless devices with their applications starting at the same time while the environmental sound can only be the same in a certain area, searching for wireless devices within a certain distance by using the location information will greatly reduce the computation load of matching.

According to one embodiment of the present invention, the matching means 550 is further configured to synchronize the environmental sound of the environment where the user is located to the environmental sounds from other wireless devices; and to compare the synchronized environmental sounds to determine other wireless devices that are in the same environment as the user, so as to rule out the possibility that no match can be found due to desynchronization between different wireless devices.

In addition, according to one embodiment of the present invention, the processing means is further configured to, in response to receiving the user's selection of wireless devices from the list of wireless devices, connect the user's wireless device with the selected wireless devices and establish a virtual community for the connected wireless devices so that the wireless devices in the community can easily communicate with one another, share information and accomplish other functions.

FIG. 6 illustrates a system 600 for establishing a connection between wireless devices according to another embodiment of the present invention, which system is implemented at a user's client side. The system 600 includes receiving means 610 configured to receive an environmental sound of an environment where a user is located, wherein the environmental sound may be collected by a microphone on the user's wireless device. The system 600 further includes sending means 620 configured to send the environmental sound to a server and selecting means 630 configured to select to-be-connected wireless devices in response to receipt of a list of wireless devices from the server. In exemplary embodiments, the list of wireless devices is a list of other wireless devices that are determined to be in the same environment as the user by the server side according to the environmental sound. Afterwards, the sending means sends related information of the selected to-be-connected wireless devices to the server so as to establish a connection with the selected wireless devices. The system 600 may further comprise connecting means 640 configured to establish a connection with the selected wireless devices.

By means of the present invention, other wireless devices can be located in a more precise way. In addition, when establishing a connection with the technique according to the present invention, it is unnecessary for people to physically face each other. It is of great value for those who are reluctant to perform fact-to-face social activities. They can get connected via an application on the wireless device first. Moreover, people can connect with others in a batch rather than one by one.

The present invention further provides a storage medium or signal carrier, which comprises instructions for executing a method according to the present invention.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks illustrated in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

As will be appreciated by one skilled in the art, the present invention may be embodied as a system, method or computer program product. Accordingly, the present invention may take the form of an entirely hardware embodiment, an entirely software embodiment (including firmware, resident software, micro-code, etc.) or one embodiment combining software and hardware aspects that may all generally be referred to herein as a “circuit,” “module” or “system.” Furthermore, aspects of the present invention may take the form of a computer program product embodied in one or more computer readable medium(s) having computer usable program code embodied thereon.

Any combination of one or more computer usable or readable medium(s) may be utilized. A computer usable or readable storage medium may be, for example, but not limited to, an electronic, magnetic, optical, electromagnetic, infrared, or semiconductor system, apparatus, or device, or propagation medium. More specific examples (a non-exhaustive list) of the computer readable medium includes the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, an optical transmission medium supporting the Internet or intranet, or a magnetic storage device. Note that the computer usable or readable medium may even be paper or other proper medium having a program printed thereon. It is because by electrically scanning such paper or other medium, for example, the program is obtained in an electronic manner and then compiled, interpreted or processed in a proper manner and where necessary, is stored in a computer memory. In the context of this document, a computer usable or readable medium may be any medium that can contain, store, convey, propagate, or transmit a program for use by or in connection with an instruction execution system, apparatus, or device. A computer usable medium may include a propagated data signal with computer readable program code embodied therein, for example, in baseband or as part of a carrier wave. Computer usable program code may be transmitted using any appropriate medium, including but not limited to wireless, wireline, optical fiber cable, RF, etc.

Computer program code for carrying out operations of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

As a detailed description of the present invention has been presented above in conjunction with the preferable solutions, it may be appreciated that the foregoing embodiments are merely for illustration rather than limiting the present invention. Those skilled in the art may make modifications to the disclosed solutions of the present invention without departing from the scope and spirit of the present invention.

1. A method for establishing a connection between wireless devices, the method comprising:
receiving from a wireless device of a user an environmental sound of an environment where the user is located;
obtaining a list of other wireless devices that are in the same environment as the user according to the environmental sound; and
sending the list of wireless devices to the user for the user to select from the list of wireless devices one or more wireless devices for connecting.

2. The method according to claim 1, wherein the obtaining a list of other wireless devices that are in the same environment as the user, according to the environmental sound comprises:
obtaining environmental sounds from other wireless devices;
matching the environmental sound of the environment where the user is located to the environmental sounds from other wireless devices, so as to determine other wireless devices that are in the same environment as the user.

3. The method according to claim 2, wherein the obtaining a list of other wireless devices that are in the same environment as the user according to the environmental sound further comprises determining other wireless devices near the wireless device of the user according to location information of the wireless device; and
the obtaining environmental sounds from other wireless devices comprises obtaining the environmental sound from the determined other wireless devices near the user's wireless device.

4. The method according to claim 3, wherein the location information is one or more of a group consisting of General Packet Radio Service GPRS information, Global Positioning System GPS information and Assisted Global Positioning System AGPS information.

5. The method according to claim 2, wherein the matching the environmental sound of the environment where the user is located to the environmental sounds from other wireless devices, so as to determine other wireless devices that are in the same environment as the user further comprises:
synchronizing the environmental sound of the environment where the user is located with the environmental sounds from other wireless devices; and
comparing the synchronized environmental sounds so as to determine other wireless devices that are in the same environment as the user.

6. The method according to claim 1, further comprising: in response to receiving the user's selection of wireless devices in the list of wireless devices, connecting the wireless device of the user with the selected wireless devices.

7. The method according to claim 6, further comprising:
establishing a virtual community for the connected wireless devices.

8. A method for establishing a connection between wireless devices, the method comprising:
receiving the environmental sound of the environment where a user is located;
sending the environmental sound to a server;
in response to receiving a list of wireless devices from the server, selecting to-be-connected wireless devices, wherein the list of wireless devices is a list of other wireless devices that are determined to be in the same environment as the user according to the environmental sound; and
sending related information of the selected to-be-connected wireless devices to the server.

9. The method according to claim 8, further comprising: establishing a connection with the selected wireless devices.

10. A system for establishing a connection between wireless devices, the system comprising:
receiving means configured to receive from a wireless device of a user an environmental sound of the environment where the user is located;
processing means configured to obtain a list of other wireless devices that are in the same environment as the user, according to the environmental sound; and
sending means configured to send the list of wireless devices to the user for the user to select from the list of wireless devices one or more wireless devices for connecting.

11. The system according to claim 10, wherein the processing means comprises:
environmental sound obtaining means configured to obtain environmental sounds from other wireless devices; and
matching means configured to match the environmental sound of the environment where the user is located to the environmental sounds from other wireless devices, so as to determine other wireless devices that are in the same environment as the user.

12. The system according to claim 11, wherein the processing means further comprises location information determining means configured to determine other wireless devices near the wireless device of the user according to location information of the wireless device; and
the environmental sound obtaining means is further configured to obtain environmental sounds from the determined other wireless devices near the user's wireless device.

13. The system according to claim 12, wherein the location information is one or more of a group consisting of General Packet Radio Service GPRS information, Global Positioning System GPS information and Assisted Global Positioning System AGPS information.

14. The system according to claim 11, wherein the matching means is further configured to:
synchronize the environmental sound of the environment where the user is located with the environmental sounds from other wireless devices; and
compare the synchronized environmental sounds so as to determine other wireless devices that are in the same environment as the user.

15. The system according to claim 10, wherein the processing means is further configured to, in response to receiving the user's selection of wireless devices in the list of wireless devices, connect the wireless device of the user with the selected wireless devices.

16. The system according to claim 15, wherein the processing means is further configured to:
establish a virtual community for the connected wireless devices.

17. A system for establishing a connection between wireless devices, the system comprising:
receiving means configured to receive the environmental sound of the environment where a user is located;
sending means configured to send the environmental sound to a server;
selecting means configured to, in response to receiving a list of wireless devices from the server, select to-be-connected wireless devices, wherein the list of wireless devices is a list of other wireless devices that are determined to be in the same environment as the user according to the environmental sound;
wherein the sending means is further configured to send related information of the selected to-be-connected wireless devices to the server.

18. The system according to claim 17, further comprising: connecting means configured to establish a connection with the selected wireless devices.

19. (canceled)
